(19) United States
(12) Patent Application Publication
(10) Pub. No.: US 2016/0353534 A1
(43) Pub. Date: Dec. 1, 2016

(54) LED LUMINANCE DEVICE AND RELATED DRIVER CIRCUIT

(71) Applicant: Richtek Technology Corporation, Chupei City (TW)

(72) Inventors: Jiun-Hung PAN, Taipei City (TW); Tong-Cheng JAO, Taichung City (TW); Yi-Wei LEE, Taipei City (TW); Isaac Y. CHEN, Hsinchu County (TW)

(73) Assignee: Richtek Technology Corporation, Chupei City (TW)

(21) Appl. No.: 15/155,857

(22) Filed: May 16, 2016

(30) Foreign Application Priority Data
Jun. 1, 2015 (TW) 104117621

(51) Int. Cl. H05B 33/08

(52) U.S. Cl. CPC H05B 33/0815; H05B 33/083; H05B 33/0827; H05B 33/0842

(57) ABSTRACT

A driver circuit of a LED luminance device includes: a signal pin; a determining circuit for determining the magnitude of an input signal; an indication signal generating circuit for outputting an indication signal to the signal pin according to the determining result of the determining circuit; an alignment signal generating circuit for generating an alignment signal when triggered by a predetermined edge of a signal at the signal pin; an indication signal detecting circuit for detecting the signal at the signal pin to generate a detection signal; and a control signal generating circuit for generating multiple control signals according to the detection signal to respectively control multiple switching elements in parallel connection with multiple LED devices when triggered by the alignment signal.

### CROSS-REFERENCE TO RELATED APPLICATIONS

This application claims the benefit of priority to Patent Application No. 104117621, filed in Taiwan on Jun. 1, 2015; the entirety of which is incorporated herein by reference for all purposes.

### BACKGROUND

The disclosure generally relates to a LED device and, more particularly, to a driver circuit capable of increasing the luminous performance of a LED luminance device.

In order to increase the luminous power, some LED luminance devices utilize multiple driver circuits in parallel connection to respectively drive multiple LED arrays. Ideally, the control signals of the multiple driver circuits in parallel connection should be switched at the same time to maximize the luminous power of the LED luminance device.

However, process variations among the driver circuits are inevitable and those driver circuits in parallel connection operate independently from each other. Accordingly, in the conventional LED luminance device, it is difficult for the driver circuits in parallel connection to switch control signals at the same time, and thus the luminous performance of the conventional LED luminance device is inevitably reduced. As a result, it not only reduces the overall energy utilization efficiency of the LED luminance device, but also generates more unnecessary heat.

### SUMMARY

In view of the foregoing, it may be appreciated that a substantial need exists for methods and apparatuses that mitigate or reduce the problems above.

An example embodiment of a LED luminance device is disclosed, comprising: a rectifier, arranged to operably generate a rectified signal based on an AC signal; a first LED array, coupled with the rectified signal and comprising multiple LED devices in series connection; a first switch array, coupled with the rectified signal and comprising multiple switch elements in series connection and multiple nodes positioned on a current path of the first switch array, wherein the multiple nodes of the first switch array are respectively coupled with the multiple LED devices of the first LED array, so that the multiple switch elements of the first switch array are respectively coupled with the multiple LED devices of the first LED array in parallel connection; a first driver circuit which comprises: a first signal pin; a determining circuit, arranged to operably determine a magnitude of an input signal; an indication signal generating circuit, coupled with the determining circuit and the first signal pin, arranged to operably output an indication signal to the first signal pin according to a determining result of the determining circuit; an alignment signal generating circuit, coupled with the first signal pin, arranged to operably generate an alignment signal when triggered by a predetermined edge of a signal at the first signal pin; an indication signal detecting circuit, coupled with the first signal pin, arranged to operably detect the signal at the first signal pin to generate a detection signal; and a control signal generating circuit, coupled with the alignment signal generating circuit, the indication signal detecting circuit, and the first switch array, arranged to operably generate multiple control signals based on the detection signal when triggered by the alignment signal to respectively control the multiple switch elements of the first switch array; a second LED array, coupled with the rectified signal and comprising multiple LED devices in series connection and multiple nodes positioned on a current path of the second LED array; a second switch array, coupled with the rectified signal and comprising multiple switch elements in series connection, wherein the multiple switch elements of the second switch array are respectively coupled with the multiple nodes of the second LED array, so that the multiple switch elements of the second switch array are respectively coupled with the multiple LED devices of the second LED array in parallel connection; and a second driver circuit, coupled with the second switch array, having same circuitry structure as the first driver circuit and arranged to operably control the multiple switch elements of the second switch array; wherein the first signal pin of the first driver circuit is coupled with a first signal pin of the second driver circuit to enable the first driver circuit and the second driver circuit to simultaneously adjust switching timings of the first switch array and the second switch array.

Another example embodiment of first driver circuit for use in a LED luminance device is disclosed. The LED luminance device comprises a rectifier, a first LED array, and a first switch array; the rectifier is arranged to operably generate a rectified signal based on an AC signal; the first LED array is coupled with the rectified signal and comprises multiple LED devices in series connection; the first switch array is coupled with the rectified signal and comprises multiple switch elements in series connection and multiple nodes positioned on a current path of the first switch array; the multiple nodes of the first switch array are respectively coupled with the multiple LED devices of the first LED array, so that the multiple switch elements of the first switch array are respectively coupled with the multiple LED devices of the first LED array in parallel connection. The first driver circuit comprises: a first signal pin; a determining circuit, arranged to operably determine a magnitude of an input signal; an indication signal generating circuit, coupled with the determining circuit and the first signal pin, arranged to operably output an indication signal to the first signal pin according to a determining result of the determining circuit; an alignment signal generating circuit, coupled with the first signal pin, arranged to operably generate an alignment signal when triggered by a predetermined edge of a signal at the first signal pin; an indication signal detecting circuit, coupled with the first signal pin, arranged to operably detect the signal at the first signal pin to generate a detection signal; and a control signal generating circuit, coupled with the alignment signal generating circuit, the indication signal detecting circuit, and the first switch array, arranged to operably generate multiple control signals based on the detection signal when triggered by the alignment signal to respectively control the multiple switch elements.

Another example embodiment of a LED luminance device is disclosed, comprising: a rectifier, arranged to operably generate a rectified signal based on an AC signal; a first LED array, coupled with the rectified signal and comprising multiple LED devices in series connection; a first switch array, coupled with the rectified signal and comprising multiple switch elements in series connection and multiple nodes positioned on a current path of the first switch array, wherein the multiple nodes of the first switch array are respectively coupled with the multiple LED devices of the first LED array, so that the multiple switch elements of the first switch array are respectively coupled with the multiple LED devices of the first LED array in parallel connection; a first driver circuit which comprises: a first signal pin; a second signal pin; a determining circuit, arranged to operably determine a magnitude of an input signal; an indication signal generating circuit, coupled with the determining circuit and the second signal pin, arranged to operably output an indication signal to the second signal pin according to a determining result of the determining circuit; an alignment signal generating circuit, coupled with the first signal pin, arranged to operably generate an alignment signal when triggered by a predetermined edge of a signal at the first signal pin; an indication signal detecting circuit, coupled with the first signal pin, arranged to operably detect the signal at the first signal pin to generate a detection signal; and a control signal generating circuit, coupled with the alignment signal generating circuit, the indication signal detecting circuit, and the first switch array, arranged to operably generate multiple control signals based on the detection signal when triggered by the alignment signal to respectively control the multiple switch elements of the first switch array; a second LED array, coupled with the rectified signal and comprising multiple LED devices in series connection and multiple nodes positioned on a current path of the second LED array; a second switch array, coupled with the rectified signal and comprising multiple switch elements in series connection, wherein the multiple switch elements of the second switch array are respectively coupled with the multiple nodes of the second LED array, so that the multiple switch elements of the second switch array are respectively coupled with the multiple LED devices of the second LED array in parallel connection; and a second driver circuit, coupled with the second switch array, having same circuitry structure as the first driver circuit and arranged to operably control the multiple switch elements of the second switch array; wherein the first signal pin and the second signal pin of the first driver circuit are both coupled with a first signal pin of the second driver circuit but not coupled with a second signal pin of the second driver circuit, so as to enable the first driver circuit and the second driver circuit to simultaneously adjust switching timings of the first switch array and the second switch array.

Another example embodiment of a first driver circuit for use in a LED luminance device is disclosed. The LED luminance device comprises a rectifier, a first LED array, and a first switch array; the rectifier is arranged to operably generate a rectified signal based on an AC signal; the first LED array is coupled with the rectified signal and comprises multiple LED devices in series connection; the first switch array is coupled with the rectified signal and comprises multiple switch elements in series connection and multiple nodes positioned on a current path of the first switch array; the multiple nodes of the first switch array are respectively coupled with the multiple LED devices of the first LED array, so that the multiple switch elements of the first switch array are respectively coupled with the multiple LED devices of the first LED array in parallel connection. The first driver circuit comprises: a first signal pin; a second signal pin; a determining circuit, arranged to operably determine a magnitude of an input signal; an indication signal generating circuit, coupled with the determining circuit and the second signal pin, arranged to operably output an indication signal to the second signal pin according to a determining result of the determining circuit; an alignment signal generating circuit, coupled with the first signal pin, arranged to operably generate an alignment signal when triggered by a predetermined edge of a signal at the first signal pin; an indication signal detecting circuit, coupled with the first signal pin, arranged to operably detect the signal at the first signal pin to generate a detection signal; and a control signal generating circuit, coupled with the alignment signal generating circuit, the indication signal detecting circuit, and the first switch array, arranged to operably generate multiple control signals based on the detection signal when triggered by the alignment signal to respectively control the multiple switch elements.

Both the foregoing general description and the following detailed description are examples and explanatory only, and are not restrictive of the invention as claimed.

### BRIEF DESCRIPTION OF THE DRAWINGS

FIG. 1 and FIG. 2 show simplified functional block diagrams of a LED luminance device according to a first embodiments of the present disclosure.

FIG. 3 shows a simplified functional block diagram of a LED luminance device according to a second embodiment of the present disclosure.

FIG. 4 and FIG. 5 show simplified functional block diagrams of a LED luminance device according to a third embodiments of the present disclosure.

FIG. 6 shows a simplified functional block diagram of a LED luminance device according to a fourth embodiment of the present disclosure.

### DETAILED DESCRIPTION

Reference is made in detail to embodiments of the invention, which are illustrated in the accompanying drawings. The same reference numbers may be used throughout the drawings to refer to the same or like parts, components, or operations.

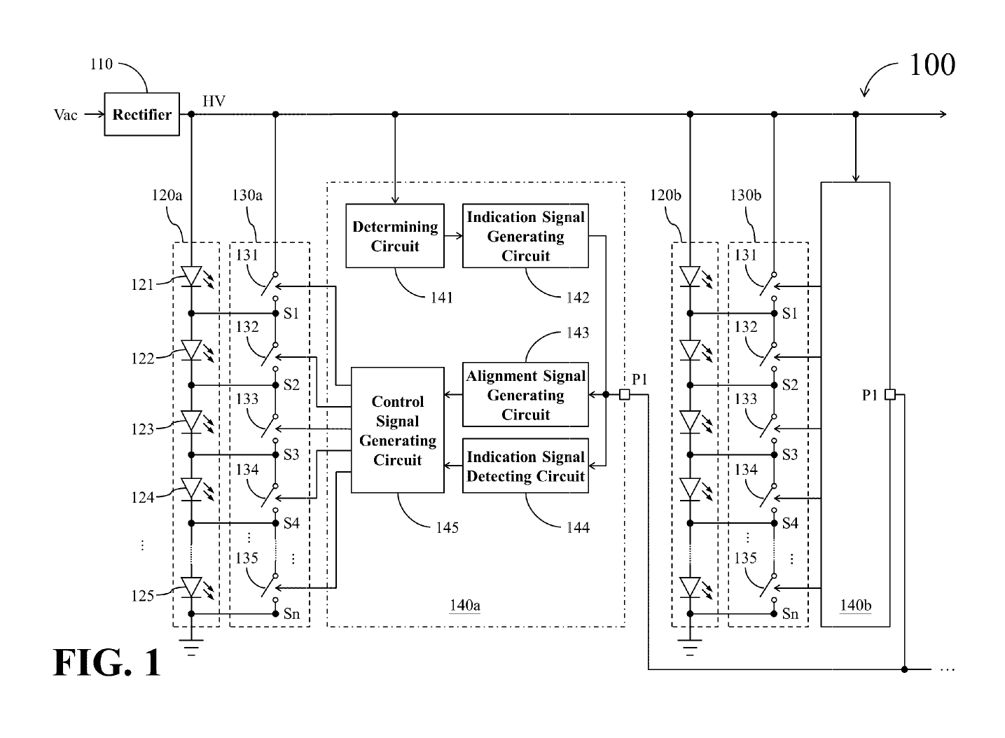

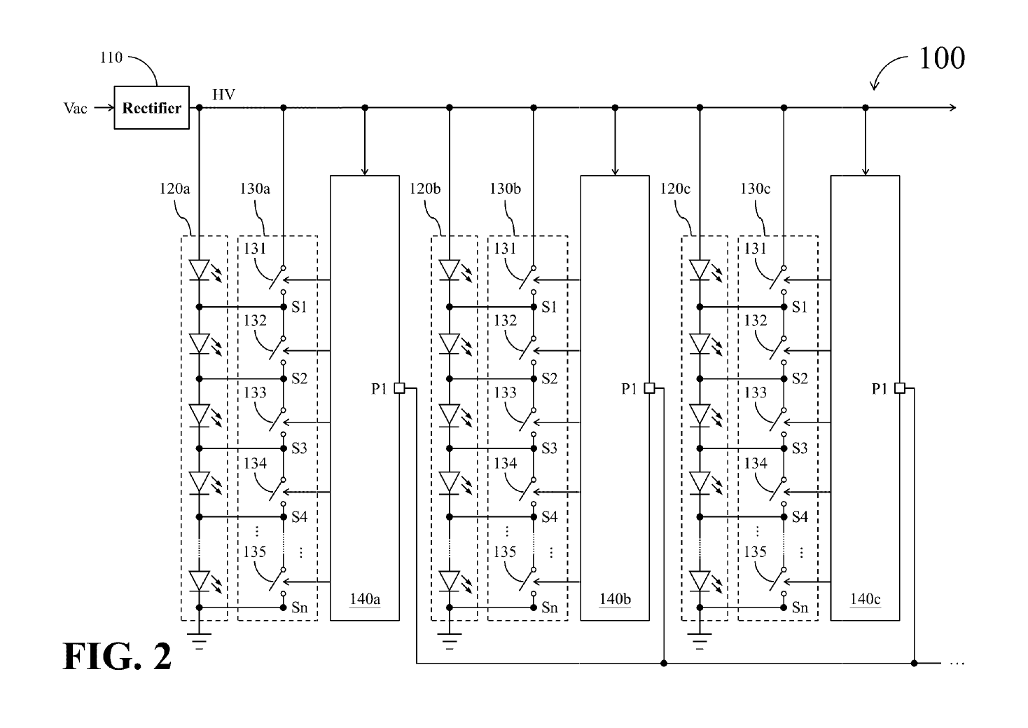

FIG. 1 and FIG. 2 show simplified functional block diagrams of a LED luminance device 100 according to a first embodiments of the present disclosure. As shown in FIG. 1 and FIG. 2, the LED luminance device 100 comprises a rectifier 110, multiple LED arrays in parallel connection, multiple switch arrays in parallel connection, and multiple driver circuits in parallel connection. For illustrative purpose, a first LED array 120a, a second LED array 120b, a third LED array 120c, a first switch array 130a, a second switch array 130b, a third switch array 130c, a first driver circuit 140a, a second driver circuit 140b, and a third driver circuit 140c are shown in FIG. 1 and FIG. 2 as an example.

The rectifier 110 is arranged to operably generate a rectified signal HV based on an AC signal Vac. The first LED array 120a is coupled with the rectified signal HV and comprises multiple LED devices in parallel connection (e.g., the LED devices 121˜125 shown in FIG. 1 and FIG. 2). Each LED device comprises one or more LED elements, and different LED devices may have the same quantity of LED elements or may have different quantity of LED elements. The first switch array 130a is coupled with the rectified signal HV. The first switch array 130a comprises multiple switch elements (e.g., the switch elements 131˜135 shown in FIG. 1 and FIG. 2) and also comprises multiple nodes S1˜Sn positioned on a current flow path of the first switch array 130a. As shown, the multiple nodes S1˜Sn of the first switch array 130a are respectively coupled with the multiple LED devices 121˜125 of the first LED array 120a, so that the multiple switch elements 131˜135 of the first switch array 130a are respectively coupled with the multiple LED devices 121˜125 of the first LED array 120a in parallel connection. The first driver circuit 140a is coupled with the first switch array 130a and arranged to operably control the operations of the multiple switch elements 131˜135 of the first switch array 130a.

As shown in FIG. 1, the first driver circuit 140a comprises a first signal pin P1, a determining circuit 141, an indication signal generating circuit 142, an alignment signal generating circuit 143, an indication signal detecting circuit 144, and a control signal generating circuit 145.

In the first driver circuit 140a, the determining circuit 141 is arranged to operably determine the magnitude of an input signal to thereby detect the phase change of the AC signal Vac. In this embodiment, the input signal of the determining circuit 141 is the rectified signal HV outputted from the rectifier 110. In practice, the determining circuit 141 may be realized with various conventional circuitry architectures capable of determining the magnitude of the rectified signal HV to generate a corresponding up signal UP or down signal DN.

The indication signal generating circuit 142 is coupled with the determining circuit 141 and the first signal pin P1, and arranged to operably output an indication signal to the first signal pin P1 according to the determining result of the determining circuit 141. For example, when the indication signal generating circuit 142 receives the determining result of the determining circuit 141, the indication signal generating circuit 142 may output a corresponding indication signal to the first signal pin P1 after a predetermined delay period has elapsed since receiving the determining result of the determining circuit 141. For example, when the indication signal generating circuit 142 receives the up signal UP, the indication signal generating circuit 142 may wait for a predetermined delay period and then output an indication signal having a first voltage level to the first signal pin P1. When the indication signal generating circuit 142 receives the down signal DN, the indication signal generating circuit 142 may wait for a predetermined delay period and then output another indication signal having a different second voltage level to the first signal pin P1.

In other words, the indication signal outputted from the indication signal generating circuit 142 to the first signal pin P1 reflects the determining result of the determining circuit 141 of the first driver circuit 140a.

In the first driver circuit 140a, the time point at which the indication signal generating circuit 142 outputs the indication signal to the first signal pin P1 represents a time point at which the first driver circuit 140a is intended to adjust the switching timing of the multiple switch elements 131˜135 of the first switch array 130a.

The alignment signal generating circuit 143 is coupled with the first signal pin P1, and arranged to operably generate an alignment signal when triggered by a predetermined edge (e.g., the raising edge or the falling edge) of the signal at the first signal pin P1.

The indication signal detecting circuit 144 is coupled with the first signal pin P1, and arranged to operably detect the signal at the first signal pin P1 to generate a detection signal. If the signal currently at the first signal pin P1 is a signal having the aforementioned first voltage level, the indication signal detecting circuit 144 may generate a signal similar with or identical to the aforementioned up signal UP to be the detection signal. If the signal currently at the first signal pin P1 is a signal having the aforementioned second voltage level, the indication signal detecting circuit 144 may generate a signal similar with or identical to the aforementioned down signal DN to be the detection signal.

The control signal generating circuit 145 is coupled with the alignment signal generating circuit 143, the indication signal detecting circuit 144, and the first switch array 130a. The control signal generating circuit 145 is arranged to operably generate multiple control signals based on the detection signal currently outputted from the indication signal detecting circuit 144 when triggered by the aforementioned alignment signal, so as to respectively control the operations of the multiple switch elements 131˜135 of the first switch array 130a.

In the embodiment of FIG. 1 and FIG. 2, the first LED array 120a, the second LED array 120b, and the third LED array 120c have same circuitry structure as each other. The first switch array 130a, the second switch array 130b, and the third switch array 130c have same circuitry structure as each other. The first driver circuit 140a, the second driver circuit 140b, and the third driver circuit 140c have same circuitry structure as each other. For example, the second LED array 120b is also coupled with the rectified signal HV. The second LED array 120b comprises multiple LED devices 121˜125 in series connection and also comprises multiple nodes S1˜Sn positioned on a current path of the second LED array 120b. The second switch array 130b is also coupled with the rectified signal HV and comprises multiple switch elements 131˜135 in series connection. Similarly, the multiple switch elements 131˜135 of the second switch array 130b are respectively coupled with the multiple nodes S1˜Sn of the second LED array 120b, so that the multiple switch elements 131˜135 of the second switch array 130b are respectively coupled with the multiple LED devices 121˜125 of the second LED array 120b in parallel connection. The second driver circuit 140b is coupled with the second switch array 130b, and arranged to operably control the operations of the multiple switch elements 131˜135 of the second switch array 130b.

In the LED luminance device 100, the combination of the first LED array 120a, the first switch array 130a, and the first driver circuit 140a constitutes a first luminance circuit set in the LED luminance device 100. The combination of the second LED array 120b, the second switch array 130b, and the second driver circuit 140b constitutes a second luminance circuit set in the LED luminance device 100. The combination of the third LED array 120c, the third switch array 130c, and the third driver circuit 140c constitutes a third luminance circuit set in the LED luminance device 100. As shown, the aforementioned first luminance circuit set, second luminance circuit set, and third luminance circuit set are coupled in parallel connection. Please note that the quantity of the luminance circuit sets in the aforementioned LED luminance device 100 is merely an example, rather than a restriction to practical implementations of the LED luminance device 100.

In the embodiment of FIG. 1 and FIG. 2, the first signal pins P1 of all driver circuits of the LED luminance device 100 are coupled together. For example, the first signal pin P1 of the first driver circuit 140a is coupled with the first signal pin P1 of the second driver circuit 140b and also coupled with the first signal pin P1 of the third driver circuit 140c. Under the aforementioned connection manner of the first signal pins P1, when any unspecific driver circuit in the LED luminance device 100 is intended to adjust the switching timing of a corresponding switch array, the indication signal outputted to the first signal pin P1 of the driver circuit by its indication signal generating circuit 142 is simultaneously applied to the first signal pins P1 of the other driver circuits in the LED luminance device 100. As a result, all driver circuits in the LED luminance device 100 are forced to simultaneously adjust the switching timing of all switch arrays at the same time.

For example, if the time point at which the indication signal generating circuit 142 of the first driver circuit 140a outputs a generated indication signal to the first signal pin P1 of the first driver circuit 140a is earlier than all other driver circuits, it means that the time point at which the first driver circuit 140a is intended to adjust the switching timing of the first switch array 130a is prior to that of all other driver circuits. At this moment, since the first signal pins P1 of all driver circuits are coupled together, the indication signal outputted to the first signal pin P1 of the first driver circuit 140a by the indication signal generating circuit 142 of the first driver circuit 140a would be simultaneously coupled to the first signal pin P1 of the second driver circuit 140b as well as the first signal pin P1 of the third driver circuit 140c.

In this situation, the alignment signal generating circuit 143 and the indication signal detecting circuit 144 of the second driver circuit 140b and the third driver circuit 140c would operate according to the indication signal generated by the indication signal generating circuit 142 of the first driver circuit 140a. As a result, the three control signal generating circuits 145 of the first driver circuit 140a, the second driver circuit 140b, and the third driver circuit 140c operate simultaneously to enable the first driver circuit 140a, the second driver circuit 140b, and the third driver circuit 140c to respectively adjust the switching timing of the first switch array 130a, the second switch array 130b, and the third switch array 130c at the same time. In other words, the time point of adjusting the switching timing of the first switch array 130a, the second switch array 130b, and the third switch array 130c is determined by the first driver circuit 140a in this situation.

For another example, if the time point at which the indication signal generating circuit 142 of the second driver circuit 140b outputs a generated indication signal to the first signal pin P1 of the second driver circuit 140b is earlier than all other driver circuits, it means that the time point at which the second driver circuit 140b is intended to adjust the switching timing of the second switch array 130b is prior to that of all other driver circuits. At this moment, since the first signal pins P1 of all driver circuits are coupled together, the indication signal outputted to the first signal pin P1 of the second driver circuit 140b by the indication signal generating circuit 142 of the second driver circuit 140b would be simultaneously coupled to the first signal pin P1 of the first driver circuit 140a as well as the first signal pin P1 of the third driver circuit 140c.

In this situation, the alignment signal generating circuit 143 and the indication signal detecting circuit 144 of the first driver circuit 140a and the third driver circuit 140c would operate according to the indication signal generated by the indication signal generating circuit 142 of the second driver circuit 140b. As a result, the three control signal generating circuits 145 of the first driver circuit 140a, the second driver circuit 140b, and the third driver circuit 140c operate simultaneously to enable the first driver circuit 140a, the second driver circuit 140b, and the third driver circuit 140c to respectively adjust the switching timing of the first switch array 130a, the second switch array 130b, and the third switch array 130c at the same time. In other words, the time point of adjusting the switching timing of the first switch array 130a, the second switch array 130b; and the third switch array 130c is determined by the second driver circuit 140b in this situation.

It can be appreciated from the foregoing descriptions that any driver circuit of the LED luminance device 100 has the chance to decide the switching timing of all switch arrays.

Since the multiple driver circuits (e.g., the driver circuits 140a, 140b, and 140c) of the LED luminance device 100 simultaneously adjust the switching timing of the multiple switch arrays (e.g., the switching arrays 130a, 130b, and 130c), the operating configurations of the multiple LED arrays (e.g., the LED arrays 120a, 120b, and 120c) in parallel connection would be changed at the same time. As a result, the switching timing mismatch in the LED luminance device 100 can be effectively avoided, thereby increasing the luminous performance and overall energy utilization efficiency of the LED luminance device 100.

In the LED luminance device 100 described previously, the input signal of the determining circuit 141 of each driver circuit is the rectified signal HV outputted from the rectifier 110. But this is merely an exemplary embodiment, rather than a restriction to practical implementations of the determining circuit 141.

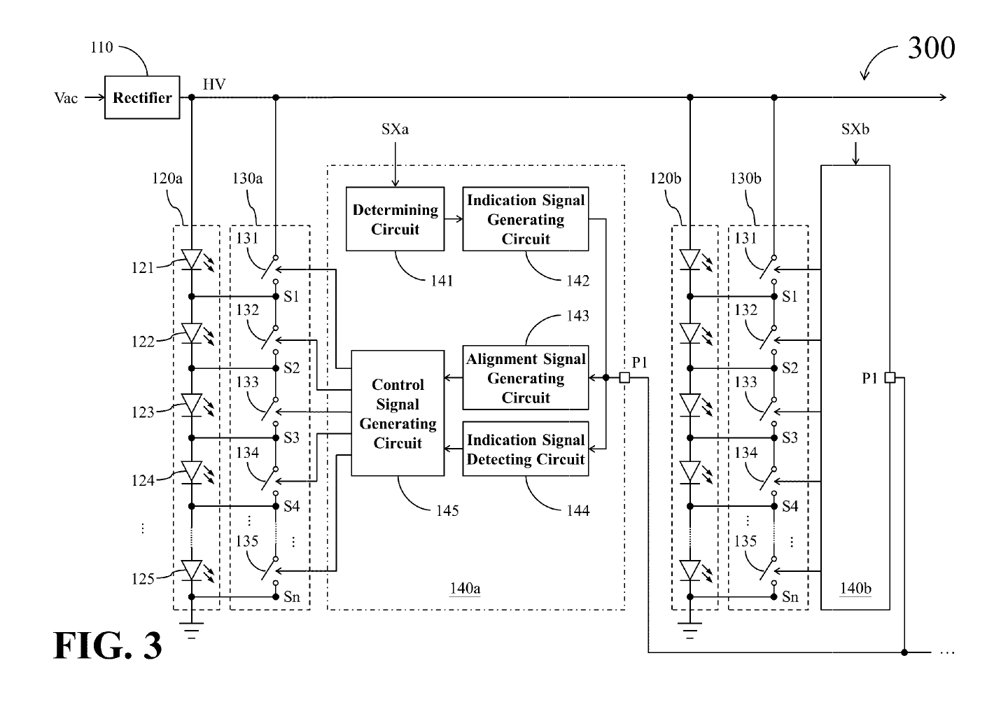

For example, FIG. 3 shows a simplified functional block diagram of a LED luminance device 300 according to a second embodiment of the present disclosure. In the LED luminance device 300, the input signal of the determining circuit 141 of each driver circuit is a signal provided by one of the multiple nodes S1˜Sn of a corresponding switch array. For example, an input signal Sxa of the determining circuit 141 in the first driver circuit 140a is the signal provided by one of the multiple nodes S1˜Sn of the first switch array 130a (e.g., the signal at the node S3 or node S4); an input signal SXb of the determining circuit 141 in the second driver circuit 140b is the signal provided by one of the multiple nodes S1˜Sn of the second switch array 130b (e.g., the signal at the node S3 or S4); and so forth.

The foregoing descriptions regarding the implementations, connections, operations, and related advantages of other corresponding functional blocks in the LED luminance device 100 are also applicable to the LED luminance device 300. For the sake of brevity, those descriptions will not be repeated here.

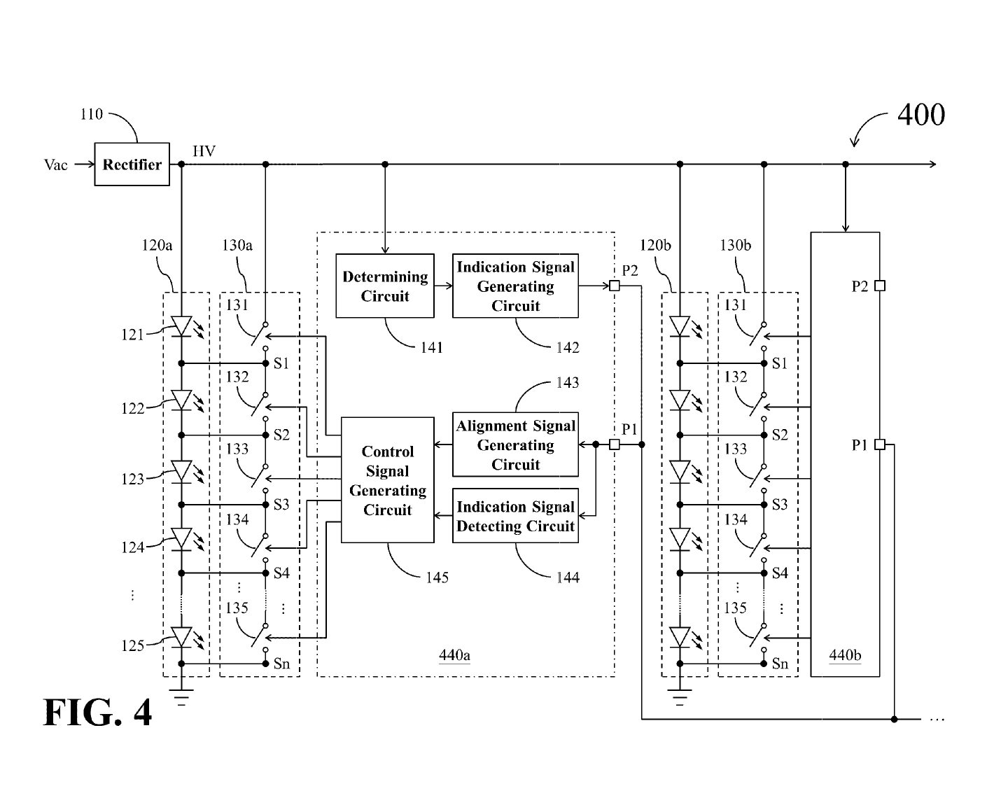

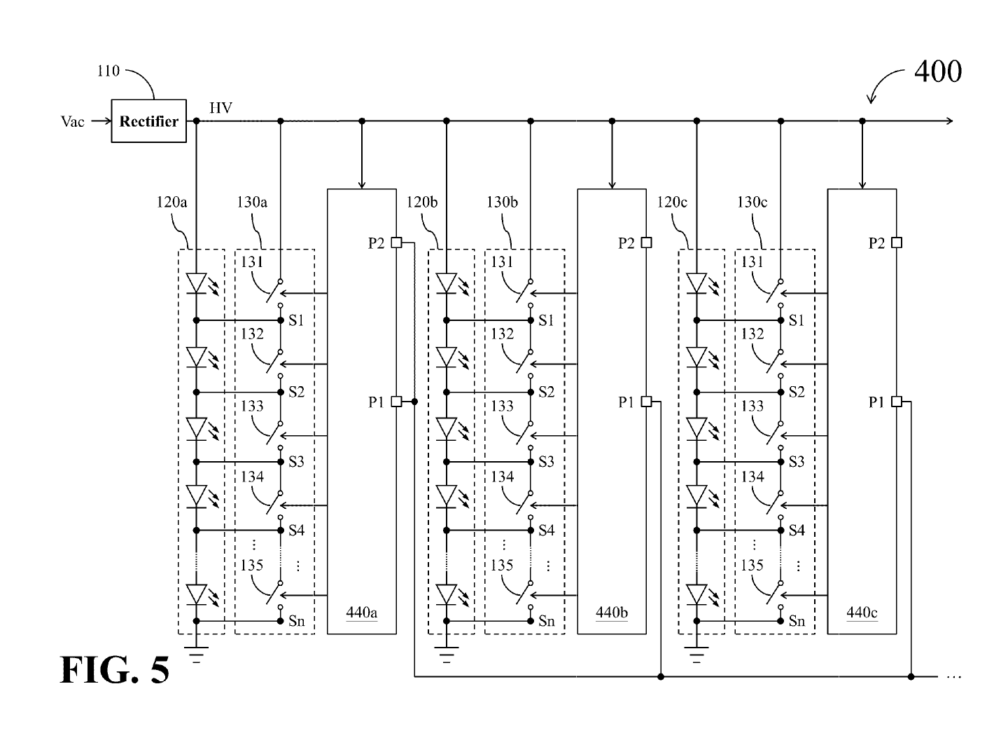

FIG. 4 and FIG. 5 show simplified functional block diagrams of a LED luminance device 400 according to a third embodiments of the present disclosure. Similar with the aforementioned LED luminance device 100, the LED luminance device 400 comprises the rectifier 110, multiple LED arrays in parallel connection, multiple switch arrays in parallel connection, and multiple driver circuits in parallel connection. For illustrative purpose, the first LED array 120a, the second LED array 120b, the third LED array 120c, the first switch array 130a, the second switch array 130b, the third switch array 130c, a first driver circuit 440a, a second driver circuit 440b, and a third driver circuit 440c are shown in FIG. 4 and FIG. 5 as an example.

The implementations and connections of the rectifier 110, the first LED array 120a, the second LED array 120b, the third LED array 120c, the first switch array 130a, the second switch array 130b, and the third switch array 130c of the LED luminance device 400 are the same as corresponding components of the LED luminance device 100 described previously. For the sake of brevity, those descriptions will not be repeated here.

As shown in FIG. 4, the first driver circuit 440a comprises the first signal pin P1, the determining circuit 141, the indication signal generating circuit 142, the alignment signal generating circuit 143, the indication signal detecting circuit 144, and the control signal generating circuit 145. In comparison with the aforementioned first driver circuit 140a, the first driver circuit 440a further comprises a second signal pin P2, and the connection relationship of the indication signal generating circuit 142 in the first driver circuit 440a is different from that of the indication signal generating circuit 142 in the first driver circuit 140a.

In the first driver circuit 440a, the indication signal generating circuit 142 is coupled with the determining circuit 141 and the second signal pin P2, and arranged to operably output an indication signal to the second signal pin P2 according to the determining result of the determining circuit 141. For example, when the indication signal generating circuit 142 receives the determining result of the determining circuit 141, the indication signal generating circuit 142 may output a corresponding indication signal to the second signal pin P2 after a predetermined delay period has elapsed since receiving the determining result of the determining circuit 141. For example, when the indication signal generating circuit 142 receives the aforementioned up signal UP, the indication signal generating circuit 142 may wait for a predetermined delay period and then output an indication signal having a first voltage level to the second signal pin P2. When the indication signal generating circuit 142 receives the aforementioned down signal DN, the indication signal generating circuit 142 may wait for a predetermined delay period and then output another indication signal having a different second voltage level to the second signal pin P2.

In other words, the indication signal outputted from the indication signal generating circuit 142 to the second signal pin P2 reflects the determining result of the determining circuit 141 of the first driver circuit 140a.

In the first driver circuit 440a, the time point at which the indication signal generating circuit 142 outputs the indication signal to the second signal pin P2 represents a time point at which the first driver circuit 440a is intended to adjust the switching timing of the multiple switch elements 131˜135 of the first switch array 130a.

The implementations and connections of the alignment signal generating circuit 143, the indication signal detecting circuit 144, and the control signal generating circuit 145 of the first driver circuit 440a are the same as corresponding components of the first driver circuit 140a described previously. For the sake of brevity, those descriptions will not be repeated here.

In the LED luminance device 400, the first driver circuit 440a, the second driver circuit 440b, and the third driver circuit 440c have same circuitry structure as each other. In addition, the combination of the first LED array 120a, the first switch array 130a, and the first driver circuit 440a constitutes a first luminance circuit set in the LED luminance device 400. The combination of the second LED array 120b, the second switch array 130b, and the second driver circuit 440b constitutes a second luminance circuit set in the LED luminance device 400. The combination of the third LED array 120c, the third switch array 130c, and the third driver circuit 440c constitutes a third luminance circuit set in the LED luminance device 400. As shown, the aforementioned first luminance circuit set, second luminance circuit set, and third luminance circuit set are coupled in parallel connection. Please note that the quantity of the luminance circuit sets in the aforementioned LED luminance device 400 is merely an example, rather than a restriction to practical implementations of the LED luminance device 400.

The first signal pins P1 of all driver circuits of the LED luminance device 400 are coupled together, but only the first signal pin P1 of the first driver circuit 440a is further coupled with the second signal pin P2 of the first driver circuit 440a. For each of the other driver circuits, the first signal pin P1 is not coupled with the second signal pin P2.

In the embodiment of FIG. 4 and FIG. 5, for example, the first signal pin P1 and the second signal pin P2 of the first driver circuit 440a are both coupled with the first signal pin P1 of the second driver circuit 440b as well as the first signal pin P1 of the third driver circuit 440c. But the first signal pin P1 and the second signal pin P2 of the first driver circuit 440a do not couple with the second signal pin P2 of the second driver circuit 440b nor the second signal pin P2 of the third driver circuit 440c.

Under the aforementioned connection manner of the signal pins, the indication signal generated by the indication signal generating circuit 142 of the first driver circuit 440a is outputted to the second signal pin P2 of the first driver circuit 440a, and is also applied to the first signal pin P1 of the first driver circuit 440a as well as the first signal pins P1 of the other driver circuits. As a result, all driver circuits in the LED luminance device 400 are forced to simultaneously adjust the switching timing of all switch arrays at the same time.

As described previously, the time point at which the indication signal generating circuit 142 outputs the indication signal to the second signal pin P2 represents a time point at which the first driver circuit 440a is intended to adjust the switching timing of the multiple switch elements 131˜435 of the first switch array 130a. At this moment, since the second signal pin P2 of the first driver circuit 440a are coupled with the first signal pin P1 of all driver circuits, the indication signal outputted to the second signal pin P2 of the first driver circuit 440a by the indication signal generating circuit 142 of the first driver circuit 440a would be simultaneously coupled to the first signal pin P1 of the second driver circuit 440b as well as the first signal pin P1 of the third driver circuit 440c.

In this situation, the alignment signal generating circuit 143 and the indication signal detecting circuit 144 of the second driver circuit 440b and the third driver circuit 440c would operate according to the indication signal generated by the indication signal generating circuit 142 of the first driver circuit 440a. As a result, the three control signal generating circuits 145 of the first driver circuit 440a, the second driver circuit 440b, and the third driver circuit 440c operate simultaneously to enable the first driver circuit 440a, the second driver circuit 440b, and the third driver circuit 440c to respectively adjust the switching timing of the first switch array 130a, the second switch array 130b, and the third switch array 130c at the same time. In other words, the time point of adjusting the switching timing of the first switch array 130a, the second switch array 130b, and the third switch array 130c is determined by the first driver circuit 440a alone in this situation.

It can be appreciated from the foregoing descriptions that only the first driver circuit 440a of the LED luminance device 400 has the decision power of the switching timing of all switch arrays, and the other driver circuits can only follow the instruction of the first driver circuit 440a to operate.

Since the multiple driver circuits (e.g., the driver circuits 440a, 440b, and 440c) of the LED luminance device 400 simultaneously adjust the switching timing of the multiple switch arrays (e.g., the switching arrays 130a, 130b, and 130c), the operating configurations of the multiple LED arrays (e.g., the LED arrays 120a, 120b, and 120c) in parallel connection would be changed at the same time. As a result, the switching timing mismatch in the LED luminance device 400 can be effectively avoided, thereby increasing the luminous performance and overall energy utilization efficiency of the LED luminance device 400.

In addition, the manufacturer of the LED luminance device 400 may arrange the driver circuit having the decision power of the switching timing of all switch arrays (e.g., the aforementioned first driver circuit 440a) in the most appropriate place in view of the actual circuitry environment to thereby improve the reliability of the overall system.

In the LED luminance device 400 described previously, the input signal of the determining circuit 141 is the rectified signal HV outputted from the rectifier 110. But this is merely an exemplary embodiment, rather than a restriction to practical implementations of the determining circuit 141.

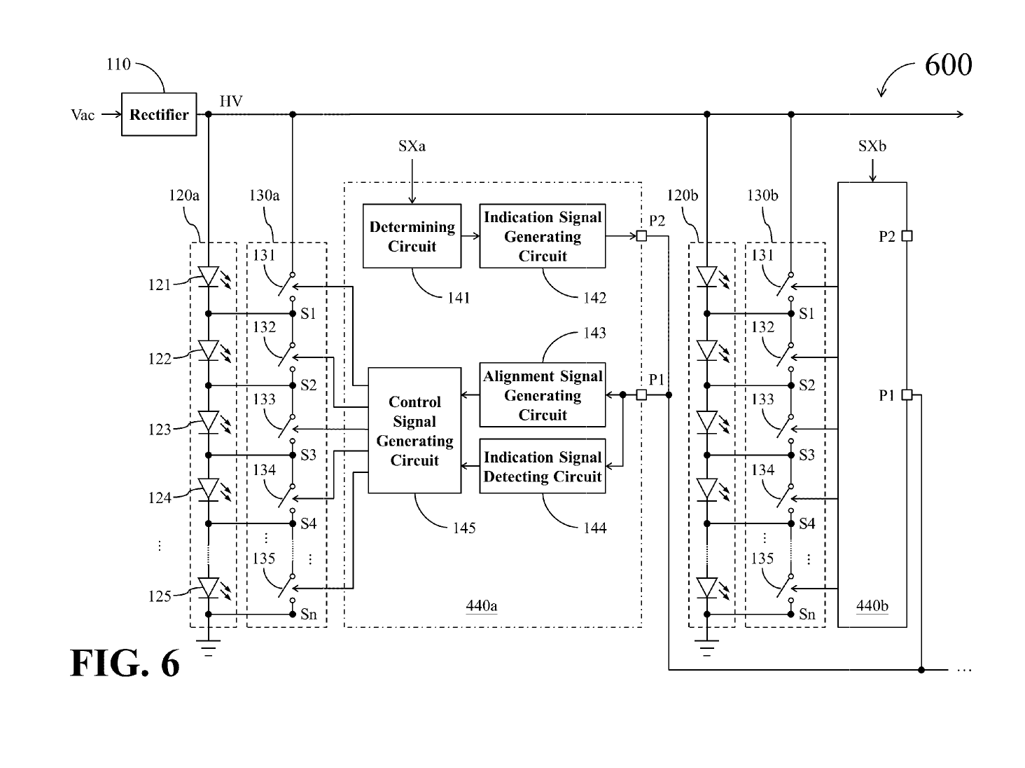

For example, FIG. 6 shows a simplified functional block diagram of a LED luminance device 600 according to a fourth embodiment of the present disclosure. In the LED luminance device 600, the input signal of the determining circuit 141 of each driver circuit is a signal provided by one of the multiple nodes S1˜Sn of a corresponding switch array. For example, an input signal Sxa of the determining circuit 141 in the first driver circuit 440a is the signal provided by one of the multiple nodes S1˜Sn of the first switch array 130a (e.g., the signal at the node S3 or node S4); an input signal SXb of the determining circuit 141 in the second driver circuit 440b is the signal provided by one of the multiple nodes S1˜Sn of the second switch array 130b (e.g., the signal at the node S3 or S4); and so forth.

The foregoing descriptions regarding the implementations, connections, operations, and related advantages of other corresponding functional blocks in the LED luminance device 400 are also applicable to the LED luminance device 600. For the sake of brevity, those descriptions will not be repeated here.

Different functional blocks of each of the LED luminance devices 100, 300, 400, or 600 may be realized with separate circuits, or may be integrated into a single circuit chip. For example, all the functional blocks of the first driver circuit 140a or 440a may be integrated into a single circuit chip. The first switch array 130a may be further integrated into the first driver circuit 140a or 440a to form a single circuitry chip. Similarly, the second switch array 130b may be further integrated into the second driver circuit 140b or 440b to form a single circuitry chip.

Certain terms are used throughout the description and the claims to refer to particular components. One skilled in the art appreciates that a component may be referred to as different names. This disclosure does not intend to distinguish between components that differ in name but not in function. In the description and in the claims, the term “comprise” is used in an open-ended fashion, and thus should be interpreted to mean “include, but not limited to.” The term “couple” is intended to compass any indirect or direct connection. Accordingly, if this disclosure mentioned that a first device is coupled with a second device, it means that the first device may be directly or indirectly connected to the second device through electrical connections, wireless communications, optical communications, or other signal connections with/without other intermediate devices or connection means.

The term “and/or” may comprise any and all combinations of one or more of the associated listed items. In addition, the singular forms “a,” “an,” and “the” herein are intended to comprise the plural forms as well, unless the context clearly indicates otherwise.

Other embodiments of the invention will be apparent to those skilled in the art from consideration of the specification and practice of the invention disclosed herein. It is intended that the specification and examples be considered as exemplary only, with a true scope and spirit of the invention indicated by the following claims.

What is claimed is:

1. A LED luminance device (100; 300), comprising:
a rectifier (110), arranged to operably generate a rectified signal (HV) based on an AC signal (Vac);
a first LED array (120a), coupled with the rectified signal (HV) and comprising multiple LED devices (121˜125) in series connection;
a first switch array (130a), coupled with the rectified signal (HV) and comprising multiple switch elements (131˜135) in series connection and also comprising multiple nodes (S1˜Sn) positioned on a current path of the first switch array (130a), wherein the multiple nodes (S1˜Sn) of the first switch array (130a) are respectively coupled with the multiple LED devices (121˜125) of the first LED array (120a), so that the multiple switch elements (131˜135) of the first switch array (130a) are respectively coupled with the multiple LED devices (121˜125) of the first LED array (120a) in parallel connection;
a first driver circuit (140a), comprising:
a first signal pin (P1);
a determining circuit (141), arranged to operably determine a magnitude of an input signal (HV; SXa);
an indication signal generating circuit (142), coupled with the determining circuit (141) and the first signal pin (P1), arranged to operably output an indication signal to the first signal pin (P1) according to a determining result of the determining circuit (141);
an alignment signal generating circuit (143), coupled with the first signal pin (P1), arranged to operably generate an alignment signal when triggered by a predetermined edge of a signal at the first signal pin (P1);
an indication signal detecting circuit (144), coupled with the first signal pin (P1), arranged to operably detect the signal at the first signal pin (P1) to generate a detection signal; and
a control signal generating circuit (145), coupled with the alignment signal generating circuit (143), the indication signal detecting circuit (144), and the first switch array (130a), arranged to operably generate multiple control signals based on the detection signal when triggered by the alignment signal to respectively control the multiple switch elements (131˜135) of the first switch array (130a);
a second LED array (120b), coupled with the rectified signal (HV) and comprising multiple LED devices (121˜125) in series connection and also comprising multiple nodes (S1˜Sn) positioned on a current path of the second LED array (120b);
a second switch array (130b), coupled with the rectified signal (HV) and comprising multiple switch elements (131˜135) in series connection, wherein the multiple switch elements (131˜135) of the second switch array (130b) are respectively coupled with the multiple nodes (S1˜Sn) of the second LED array (120b), so that the multiple switch elements (131˜135) of the second switch array (130b) are respectively coupled with the multiple LED devices (121˜125) of the second LED array (120b) in parallel connection; and
a second driver circuit (140b), coupled with the second switch array (130b), having same circuitry structure as the first driver circuit (140a) and arranged to operably control the multiple switch elements (131˜135) of the second switch array (130b);
wherein the first signal pin (P1) of the first driver circuit (140a) is coupled with a first signal pin (P1) of the second driver circuit (140b) to enable the first driver circuit (140a) and the second driver circuit (140b) to simultaneously adjust switching timings of the first switch array (130a) and the second switch array (130b).

2. The LED luminance device (100) of claim 1, wherein the input signal of the determining circuit (141) is the rectified signal (HV) outputted from the rectifier (110).

3. The LED luminance device (300) of claim 1, wherein the input signal of the determining circuit (141) is a signal (Sxa) provided by one of the multiple nodes (SL-Sn) of the first switch array (130a).

4. The LED luminance device (100; 300) of claim 1, wherein a time point of adjusting the switching timing of the first switch array (130a) and the second switch array (130b) is determined by one of the first driver circuit (140a) and the second driver circuit (140b).

5. The LED luminance device (100; 300) of claim 1, wherein the indication signal generating circuit (142) outputs the indication signal to the first signal pin (P1) after a predetermined delay period has elapsed since receiving the determining result of the determining circuit (141).

6. A first driver circuit (140a) for use in a LED luminance device (100; 300), wherein the LED luminance device (100; 300) comprises a rectifier (110), a first LED array (120a), and a first switch array (130a); the rectifier (110) is arranged to operably generate a rectified signal (HV) based on an AC signal (Vac); the first LED array (120a) is coupled with the rectified signal (HV) and comprises multiple LED devices (121˜125) in series connection; the first switch array (130a) is coupled with the rectified signal (HV) and comprises multiple switch elements (131˜135) in series connection and also comprises multiple nodes (S1˜Sn) positioned on a current path of the first switch array (130a); the multiple nodes (S1˜Sn) of the first switch array (130a) are respectively coupled with the multiple LED devices (121˜125) of the first LED array (120a), so that the multiple switch elements (131˜135) of the first switch array (130a) are respectively coupled with the multiple LED devices (121˜125) of the first LED array (120a) in parallel connection, the first driver circuit (140a) comprising:
a first signal pin (P1);
a determining circuit (141), arranged to operably determine a magnitude of an input signal (HV; SXa);
an indication signal generating circuit (142), coupled with the determining circuit (141) and the first signal pin (P1), arranged to operably output an indication signal to the first signal pin (P1) according to a determining result of the determining circuit (141);
an alignment signal generating circuit (143), coupled with the first signal pin (P1), arranged to operably generate an alignment signal when triggered by a predetermined edge of a signal at the first signal pin (P1);
an indication signal detecting circuit (144), coupled with the first signal pin (P1), arranged to operably detect the signal at the first signal pin (P1) to generate a detection signal; and
a control signal generating circuit (145), coupled with the alignment signal generating circuit (143), the indication signal detecting circuit (144), and the first switch array (130a), arranged to operably generate multiple control signals based on the detection signal when triggered by the alignment signal to respectively control the multiple switch elements (131˜135).

7. The first driver circuit (140a) of claim 6, wherein the input signal of the determining circuit (141) is the rectified signal (HV) outputted from the rectifier (110).

8. The first driver circuit (140a) of claim 6, wherein the input signal of the determining circuit (141) is a signal (Sxa) provided by one of the multiple nodes (S1˜Sn) of the first switch array (130a).

9. The first driver circuit (140a) of claim 6, wherein the LED luminance device (100; 300) further comprises a second LED array (120b), a second switch array (130b), and a second driver circuit (140b); the second LED array (120b) is coupled with the rectified signal (HV) and comprises multiple LED devices (121˜125) in series connection and also comprises multiple nodes (S1˜Sn) positioned on a current path of the second LED array (120b); the second switch array (130b) is coupled with the rectified signal (HV) and comprises multiple switch elements (131˜135) in series connection; the multiple switch elements (131˜135) of the second switch array (130b) are respectively coupled with the multiple nodes (S1˜Sn) of the second LED array (120b), so that the multiple switch elements (131˜135) of the second switch array (130b) are respectively coupled with the multiple LED devices (121˜125) of the second LED array (120b) in parallel connection; the second driver circuit (140b) is coupled with the second switch array (130b), has same circuitry structure as the first driver circuit (140a), and is arranged to operably control the multiple switch elements (131˜135) of the second switch array (130b);
wherein the first signal pin (P1) of the first driver circuit (140a) is utilized for coupling with a first signal pin (P1) of the second driver circuit (140b) to enable the first driver circuit (140a) and the second driver circuit (140b) to simultaneously adjust switching timings of the first switch array (130a) and the second switch array (130b).

10. The first driver circuit (140a) of claim 9, wherein a time point of adjusting the switching timing of the first switch array (130a) and the second switch array (130b) is determined by one of the first driver circuit (140a) and the second driver circuit (140b).

11. The first driver circuit (140a) of claim 6, wherein the indication signal generating circuit (142) outputs the indication signal to the first signal pin (P1) after a predetermined delay period has elapsed since receiving the determining result of the determining circuit (141).

12. A LED luminance device (400; 600), comprising:
a rectifier (110), arranged to operably generate a rectified signal (HV) based on an AC signal (Vac);
a first LED array (120a), coupled with the rectified signal (HV) and comprising multiple LED devices (121˜125) in series connection;
a first switch array (130a), coupled with the rectified signal (HV) and comprising multiple switch elements (131˜135) in series connection and also comprising multiple nodes (S1˜Sn) positioned on a current path of the first switch array (130a), wherein the multiple nodes (S1˜Sn) of the first switch array (130a) are respectively coupled with the multiple LED devices (121˜125) of the first LED array (120a), so that the multiple switch elements (131˜135) of the first switch array (130a) are respectively coupled with the multiple LED devices (121˜125) of the first LED array (120a) in parallel connection;
a first driver circuit (440a), comprising:
a first signal pin (P1);
a second signal pin (P2);
a determining circuit (141), arranged to operably determine a magnitude of an input signal (HV; SXa);
an indication signal generating circuit (142), coupled with the determining circuit (141) and the second signal pin (P2), arranged to operably output an indication signal to the second signal pin (P2) according to a determining result of the determining circuit (141);
an alignment signal generating circuit (143), coupled with the first signal pin (P1), arranged to operably generate an alignment signal when triggered by a predetermined edge of a signal at the first signal pin (P1);
an indication signal detecting circuit (144), coupled with the first signal pin (P1), arranged to operably detect the signal at the first signal pin (P1) to generate a detection signal; and
a control signal generating circuit (145), coupled with the alignment signal generating circuit (143), the indication signal detecting circuit (144), and the first switch array (130a), arranged to operably generate multiple control signals based on the detection signal when triggered by the alignment signal to respectively control the multiple switch elements (131˜135) of the first switch array (130a);
a second LED array (120b), coupled with the rectified signal (HV) and comprising multiple LED devices (121˜125) in series connection and also comprising multiple nodes (S1˜Sn) positioned on a current path of the second LED array (120b);
a second switch array (130b), coupled with the rectified signal (HV) and comprising multiple switch elements (131˜135) in series connection, wherein the multiple switch elements (131˜135) of the second switch array (130b) are respectively coupled with the multiple nodes (S1˜Sn) of the second LED array (120b), so that the multiple switch elements (131˜135) of the second switch array (130b) are respectively coupled with the multiple LED devices (121˜125) of the second LED array (120b) in parallel connection; and
a second driver circuit (440b), coupled with the second switch array (130b), having same circuitry structure as the first driver circuit (440a) and arranged to operably control the multiple switch elements (131˜135) of the second switch array (130b);
wherein the first signal pin (P1) and the second signal pin (P2) of the first driver circuit (440a) are both coupled with a first signal pin (P1) of the second driver circuit (440b) but not coupled with a second signal pin (P2) of the second driver circuit (440b), so as to enable the first driver circuit (440a) and the second driver circuit (440b) to simultaneously adjust switching timings of the first switch array (130a) and the second switch array (130b).

13. The LED luminance device (400) of claim 12, wherein the input signal of the determining circuit (141) is the rectified signal (HV) outputted from the rectifier (110).

14. The LED luminance device (600) of claim 12, wherein the input signal of the determining circuit (141) is a signal (Sxa) provided by one of the multiple nodes (S1˜Sn) of the first switch array (130a).

15. The LED luminance device (400; 600) of claim 12, wherein a time point of adjusting the switching timing of the first switch array (130a) and the second switch array (130b) is determined by the first driver circuit (440a) alone.

16. The LED luminance device (400; 600) of claim 12, wherein the indication signal generating circuit (142) outputs the indication signal to the second signal pin (P2) after a predetermined delay period has elapsed since receiving the determining result of the determining circuit (141).

17. A first driver circuit (440a) for use in a LED luminance device (400; 600), wherein the LED luminance device (400; 600) comprises a rectifier (110), a first LED array (120a), and a first switch array (130a); the rectifier (110) is arranged to operably generate a rectified signal (HV) based on an AC signal (Vac); the first LED array (120a) is coupled with the rectified signal (HV) and comprises multiple LED devices (121˜125) in series connection; the first switch array (130a) is coupled with the rectified signal (HV) and comprises multiple switch elements (131˜135) in series connection and also comprises multiple nodes (S1˜Sn) positioned on a current path of the first switch array (130a); the multiple nodes (S1˜Sn) of the first switch array (130a) are respectively coupled with the multiple LED devices (121˜125) of the first LED array (120a), so that the multiple switch elements (131˜135) of the first switch array (130a) are respectively coupled with the multiple LED devices (121˜125) of the first LED array (120a) in parallel connection, the first driver circuit (440a) comprising:
a first signal pin (P1);
a second signal pin (P2);
a determining circuit (141), arranged to operably determine a magnitude of an input signal (HV; SXa);
an indication signal generating circuit (142), coupled with the determining circuit (141) and the second signal pin (P2), arranged to operably output an indication signal to the second signal pin (P2) according to a determining result of the determining circuit (141);
an alignment signal generating circuit (143), coupled with the first signal pin (P1), arranged to operably generate an alignment signal when triggered by a predetermined edge of a signal at the first signal pin (P1);
an indication signal detecting circuit (144), coupled with the first signal pin (P1), arranged to operably detect the signal at the first signal pin (P1) to generate a detection signal; and
a control signal generating circuit (145), coupled with the alignment signal generating circuit (143), the indication signal detecting circuit (144), and the first switch array (130a), arranged to operably generate multiple control signals based on the detection signal when triggered by the alignment signal to respectively control the multiple switch elements (131˜135).

18. The first driver circuit (440a) of claim 17, wherein the input signal of the determining circuit (141) is the rectified signal (HV) outputted from the rectifier (110).

19. The first driver circuit (440a) of claim 17, wherein the input signal of the determining circuit (141) is a signal (Sxa) provided by one of the multiple nodes (S1˜Sn) of the first switch array (130a).

20. The first driver circuit (440a) of claim 17, wherein the LED luminance device (400; 600) further comprises a second LED array (120b), a second switch array (130b), and a second driver circuit (440b); the second LED array (120b) is coupled with the rectified signal (HV) and comprises multiple LED devices (121˜125) in series connection and also comprises multiple nodes (S1˜Sn) positioned on a current path of the second LED array (120b); the second switch array (130b) is coupled with the rectified signal (HV) and comprises multiple switch elements (131˜135) in series connection; the multiple switch elements (131˜135) of the second switch array (130b) are respectively coupled with the multiple nodes (S1˜Sn) of the second LED array (120b), so that the multiple switch elements (131˜135) of the second switch array (130b) are respectively coupled with the multiple LED devices (121˜125) of the second LED array (120b) in parallel connection; the second driver circuit (440b) is coupled with the second switch array (130b), has same circuitry structure as the first driver circuit (440a), and is arranged to operably control the multiple switch elements (131˜135) of the second switch array (130b);
wherein the first signal pin (P1) and the second signal pin (P2) of the first driver circuit (440a) are both utilized for coupling with a first signal pin (P1) of the second driver circuit (440b), but not utilized for coupling with a second signal pin (P2) of the second driver circuit (440b), so as to enable the first driver circuit (440a) and the second driver circuit (440b) to simultaneously adjust switching timings of the first switch array (130a) and the second switch array (130b).

21. The first driver circuit (440a) of claim 20, wherein a time point of adjusting the switching timing of the first switch array (130a) and the second switch array (130b) is determined by the first driver circuit (440a) alone.

22. The first driver circuit (440a) of claim 17, wherein the indication signal generating circuit (142) outputs the indication signal to the second signal pin (P2) after a predetermined delay period has elapsed since receiving the determining result of the determining circuit (141).
